(19) United States
(12) Patent Application Publication
(10) Pub. No.: US 2009/0037870 A1
(43) Pub. Date: Feb. 5, 2009

(54) Capturing realflows and practiced processes in an IT governance system

(76) Inventor: Lucinio Santos-Gomez, Durham, NC (US)

Correspondence Address: HAMILTON & TERRILE, LLP;IBM RSW, P.O. BOX 203518, AUSTIN, TX, 78720, US

(21) Appl. No.: 11/831,489

(22) Filed: Jul. 31, 2007

(51) Int. Cl. G06F 9/44

(52) U.S. Cl. 717/101

(57) ABSTRACT

A method, system and program are disclosed for capturing information technology (IT) process flow step information within an IT governance system. A baton token is coupled to a process-flow-triggering resource. The baton token collects actual, or realflow, process step information as the resource progresses through the process flow steps of a predetermined IT process. Conversion operations are performed to convert actual process step information collected by the baton token into a realflow process flow representation. Comparison operations are then performed between the realflow process flow representation and a desired process flow representation. Differences between the two process flows are reconciled to produce a reconciled process flow.

### BACKGROUND OF THE INVENTION

1. Field of the Invention

The present invention relates in general to the field of computers and similar technologies, and in particular to software utilized in this field. Still more particularly, it relates to monitoring and verifying process flows.

2. Description of the Related Art

Today's global businesses require a higher degree of flexibility and need to use their resources effectively to stay competitive. These demands are transforming many information technology (IT) organizations as they assume a broader set of responsibilities. In addition to developing and maintaining applications, they also evaluate, acquire, and integrate software products and services into complex systems, often with stringent quality and regulatory requirements. These activities require effective “governance”—clear chains of responsibility, authority, and communication, in combination with measurement, policy, and control mechanisms.

Governance is different from management in that it does not involve operational decisions; instead, governance is the process of determining and enforcing policies regarding the authority to make decisions. Effective governance enables an organization to realize its goals by providing effective measurement and control while simultaneously facilitating effective communications between stakeholders. IT organizations commonly use governance frameworks to assign decision rights, and to also institute mechanisms and policies that are used to measure and control the way decisions are made and carried out. Consequently, IT governance is gaining recognition as an effective means of regaining control of IT expenditures and return on investment (ROI).

One element of IT governance is the definition of processes that manage the development cycle in an organization. Examples of such processes include submission of work proposals, prioritization, approvals, skill balancing and assignments, design approval cycles, development, change management, deployment, and support. Traditionally, the definition of these processes takes place in a top-down fashion. For example, a process engineer may model an IT development process using a development methodology such as the Rational Unified Process (RUP) and its corresponding process modeling tools. However, without reliable knowledge of the actual practices that take place in the organization, the engineer may unintentionally define a process that is not as effective as desired. As a result, the promises and benefits of a comprehensive IT governance system may not be fully realized.

### BRIEF SUMMARY OF THE INVENTION

A method, system and computer readable medium are disclosed for capturing information technology (IT) process flow step information within an IT governance system. In various embodiments of the invention, process resource is used to perform a set of processing steps corresponding to an actual IT process flow comprising a plurality of individual process flow steps. A token file associated with the process resource is configured to store process flow step information corresponding to individual steps in the actual IT process flow. Process flow step information for each process flow step is stored in the token file. The process flow step information stored in the token file is converted into a process flow representation comprising a set of actual process flow steps of the IT process flow and the set of actual process flow steps is compared to a set of desired process flow steps corresponding to a desired IT process flow. A difference set of process is then generated, with the difference set comprising: a) actual process flow steps not contained in the set of desired process flow steps; and b) desired process flow steps not contained in the set of actual process flow steps.

In some embodiments of the invention the actual IT process flow is modified by removing predetermined actual process flow steps in the difference set from the set of actual process steps in the actual IT process flow. In other embodiments of the invention, the actual IT process flow is modified by adding predetermined desired process flow steps in the difference set to the set of actual process steps in the actual IT process flow. In some embodiments of the invention, the actual IT process flow is modified by adding all desired process flow steps in the difference set and deleting all actual process flow steps in the difference sets. In other embodiments of the invention, the desired IT process flow steps are used to generate a desired work breakdown structure. The desired work breakdown structure can be used to modify the actual IT process flow in accordance with predetermined governance constraints.

The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a generalized block diagram of a system for using a baton token file to capture process flow information for capturing realflow process steps in accordance with an embodiment of the invention;

FIGS. 3a-b are flowcharts of a method for capturing realflow process steps in accordance with an embodiment of the invention; and

FIGS. 4a-c are simplified block diagrams of a system for using baton token files for the reconciliation of realflow process steps with desired process steps in accordance with an embodiment of the invention.

### DETAILED DESCRIPTION

A method, system and program are disclosed for capturing information technology (IT) process flow step information within an IT governance system. As will be appreciated by one skilled in the art, the present invention may be embodied as a method, system, or computer program product. Accordingly, embodiments of the invention may be implemented entirely in hardware, entirely in software (including firmware, resident software, micro-code, etc.), or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

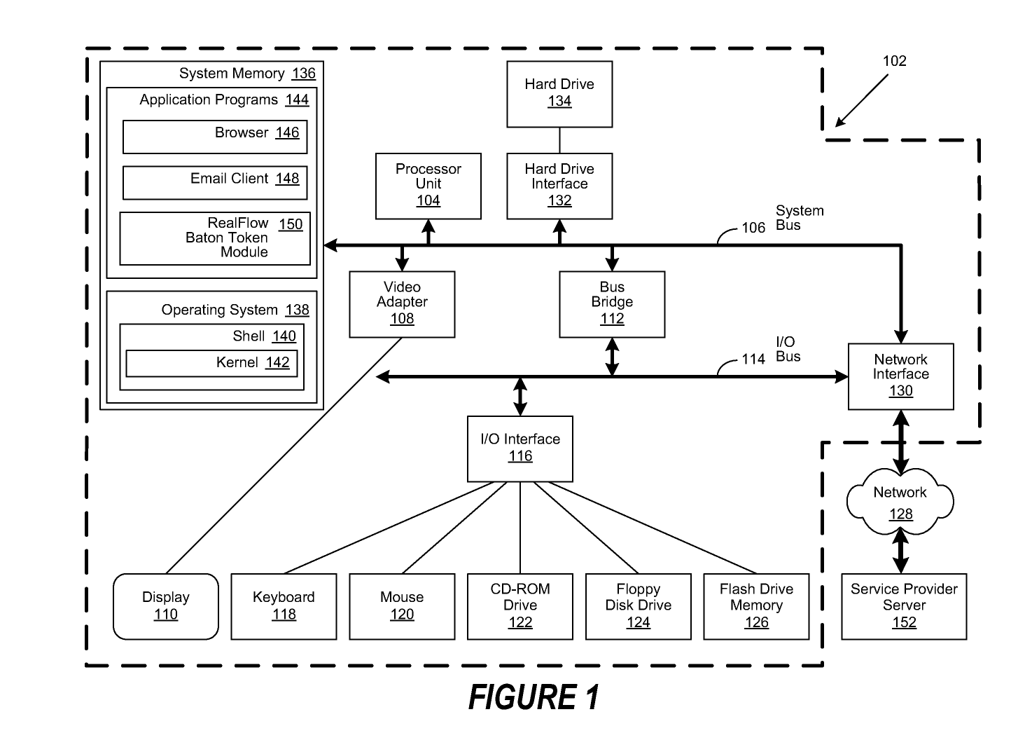

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

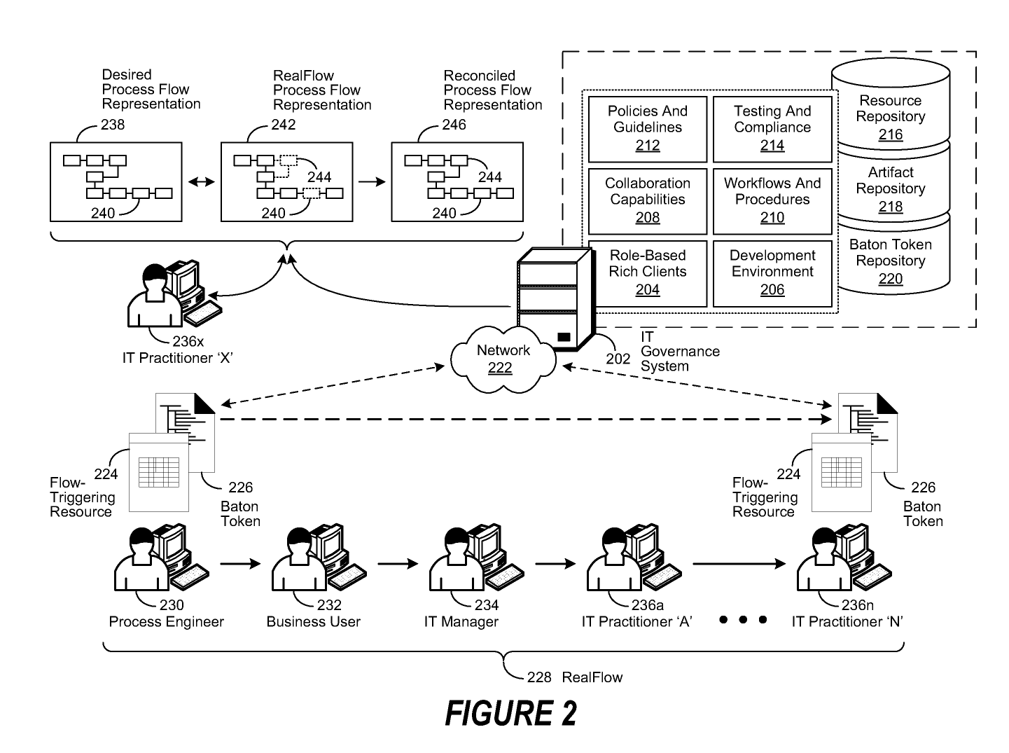

As depicted, OS 138 also includes kernel 142, which includes lower levels of functionality for OS 138, including essential services required by other parts of OS 138 and application programs 144, including memory management, process and task management, disk management, and mouse and keyboard management. Application programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. Application programs 144 also include a baton token module 150 that comprises code for generating a baton token file and for implementing the processes described in FIGS. 2-4 hereinbelow. In one embodiment, client computer 102 is able to download baton token module 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a block diagram of a system for using a baton token file for capturing realflow process steps in accordance with an embodiment of the invention. In various embodiments, information technology (IT) governance system 202 comprises role-based rich clients 204, development environment 206, and collaboration capabilities 208. IT governance system 202 also comprises workflows and procedures module 210, policies and guidelines module 212, and testing and compliance systems module 214. The IT governance system 202 further comprises resource repository 216, artifact repository 218, and baton token repository 220.

Role-based rich clients 204 provide predetermined functionality according to stakeholder job responsibilities, such as process engineer 230, business user 232, IT manager 234, IT practitioners ‘A’-‘N’ 236a-n, and IT practitioner ‘X’ 236x. Development environment 206 comprises modules and functionality familiar to those of skill in the art, and typically includes a source code editor, a compiler, a debugger, and a version control system such as concurrent versioning system (CVS). In different embodiments, development environment 206 may also comprise a class browser, an object inspector, and a class hierarchy.

Collaboration capabilities module 208 provides mechanisms for stakeholders 230, 232, 234, 236a-n, and 236x to collaborate with each other in the course of participating in the workflows and procedures 210 that make up a predetermined IT process. Testing and compliance systems 214 providing verification and validation testing to assess adherence to policies and guidelines 212, which provide the rules and guidance for the implementation of predetermined IT processes. Resource repository 216 comprises applications, templates, objects and data used or produced by a process, such as process-flow-triggering resource 224. Artifact repository 218 comprises resources used by instances of artifact data generated using selected processes from the resource repository 216 during a process flow, such as realflow 228. As such, artifacts may include inputs, scripts, workflows, set-up procedures, expected results, files, databases, environments, software, subroutines, utilities and documentation used in a predetermined IT process. Baton tokens repository 220 comprises baton token files that are used in various embodiments of the invention to capture a plurality of process flow step information.

In one embodiment, IT governance system 202 generates a baton token file 226, which comprises an extensible mark-up language (XML) document. The baton token 226 is then coupled to process-flow-triggering resource 224. As the flow triggering resource 224 progresses through the process flow steps of a predetermined IT process, baton token 226 collects actual realflow process step information 228 as it is passed via network 222 from one stakeholder to another. In this embodiment, process step information of realflow 228 is collected and stored in the baton token file 226 using an XML format such as:

```
<?xml version=”1.0” encoding=”ISO-8859-1”?>
  - <BATON>
    - <STEP>
      <ARTIFACT>Requirement</ARTIFACT>
      <ROLE>Business User</ROLE>
      <USER>Erica Jones</ROLE>
      <DATE>05092005</DATE>
      <TIME>1117</TIME>
      <ACTION>Submitted</ACTION>
      <ACTIONPARAMETER></ACTIONPARAMETER>
      <RESOURCE></RESOURCE>
    <STEP>
    - <STEP>
      <ARTIFACT>Requirement</ARTIFACT>
      <ROLE>IT Manager</ROLE>
      <USER>Ruth Benstar</ROLE>
      <DATE>05112005</DATE>
      <TIME>1539</TIME>
      <ACTION>Prioritized</ACTION>
      <ACTIONPARAMETER>Priority1
</ACTIONPARAMETER>
      <RESOURCE></RESOURCE>
    <STEP>
    - <STEP>
      <ARTIFACT>Requirement</ARTIFACT>
      <ROLE>IT Practitioner</ROLE>
      <USER>Krista Ludwig</ROLE>
      <DATE>05232005</DATE>
      <TIME>1101</TIME>
      <ACTION>CreateDesignDocument</ACTION>
      <ACTIONPARAMETER>OnlineCatalogUpdate
</ACTIONPARAMETER>
      <RESOURCE> OnlineCatalogUpdate.doc</RESOURCE>
    <STEP>
    - <STEP>
      <ARTIFACT>Requirement</ARTIFACT>
      <ROLE>IT Practitioner</ROLE>
      <USER>Sam Spencer</ROLE>
      <DATE>05252005</DATE>
      <TIME>0941</TIME>
      <ACTION>CMROpened</ACTION>
      <ACTIONPARAMETER>RATLC3200102
</ACTIONPARAMETER>
      <RESOURCE></RESOURCE>
    <STEP>
    - <STEP>
      <ARTIFACT>Requirement</ARTIFACT>
      <ROLE>IT Practitioner</ROLE>
      <USER>Sam Spencer</ROLE>
      <DATE>06262005</DATE>
      <TIME>0831</TIME>
      <ACTION>ProjectCreated</ACTION>
      <ACTIONPARAMETER>UpdateWebSiteCatalog
</ACTIONPARAMETER>
      <RESOURCE></RESOURCE>
    <STEP>
    - <STEP>
      ...
      ...
    <STEP>
    - </Baton>
```

Upon conclusion of the realflow 228 process flow steps of the predetermined IT process, the baton token 226, with its collected process flow step information, is returned via network 222 to IT governance system 202, where it is stored in baton token repository 220. IT practitioner ‘X’ 236x then retrieves the baton token 226 from baton token repository 220 and performs conversion operations to convert the actual process step information contained in baton token 226 into RealFlow process flow representation 242. Comparison operations are then performed to compare the desired process flow representation 238 to the realflow process flow representation 242. During the comparison operations IT practitioner ‘X’ 236x discovers that desired process flow representation 238 comprises process step 240, which was not captured by the baton token 226 as a process step involving process-flow-triggering resource 224 in realflow 228. Conversely, realflow process flow representation 242 comprises process step 244, which was not a process step in desired process flow representation 238.

Reconciliation operations are then performed by IT practitioner ‘X’ 236x between desired process flow representation 238 and realflow process flow representation 242. During the reconciliation operations, IT practitioner ‘X’ 236x determines that the predetermined IT process can be optimized by the inclusion of both process step 244, which was captured by the baton token 226, and process step 240, which was not. Accordingly, the two process steps are included as part of the optimization of the predetermined IT process, resulting in the generation of reconciled process flow representation 246.

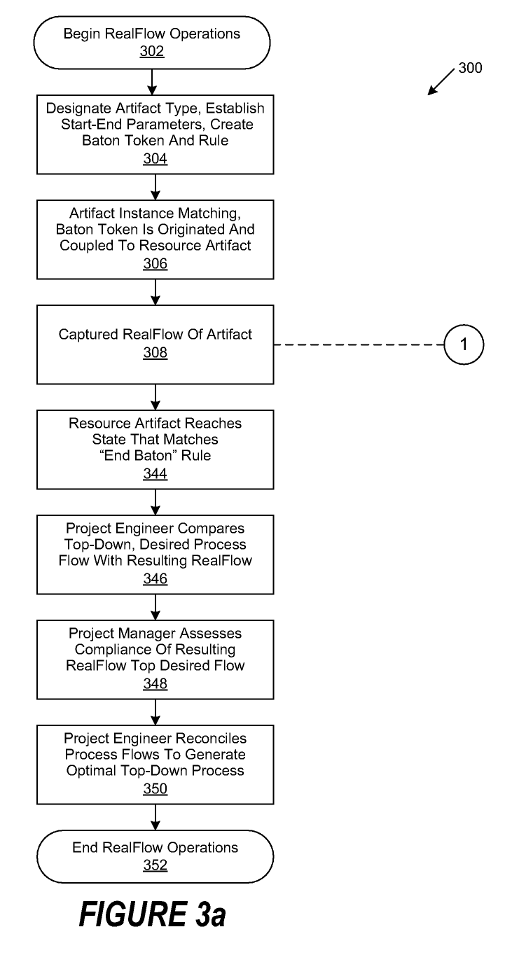

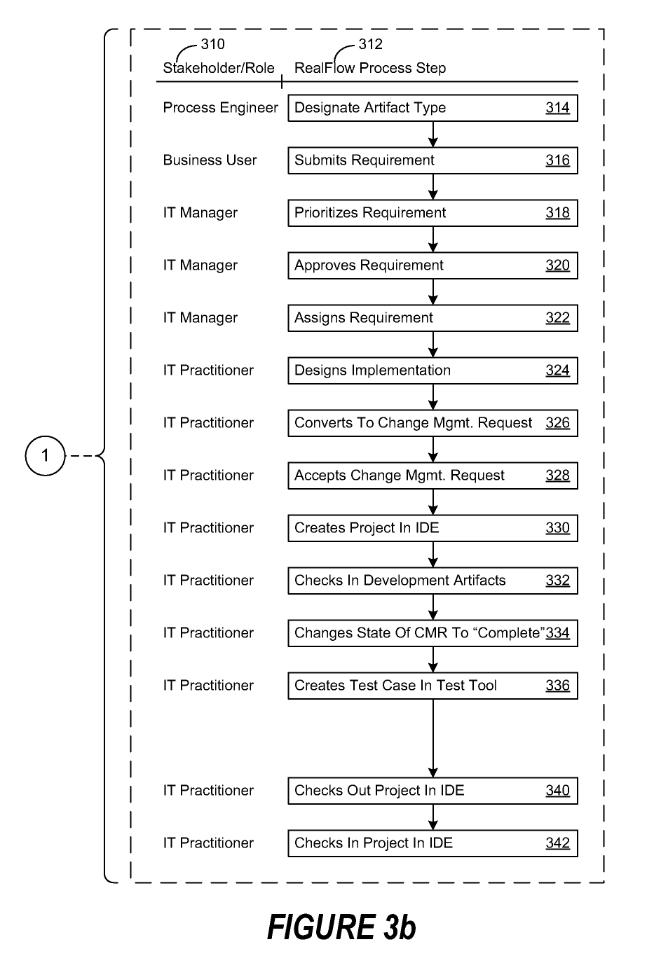

FIGS. 3a-b are simplified flowcharts of a method for using a baton token for capturing realflow process steps 300 in accordance with an embodiment of the invention. In various embodiments, realflow process step operations begin in step 302 for a predetermined IT process. In step 304, a predetermined artifact, such as a requirements document, is designated as a process-flow-triggering resource in a predetermined IT process. Process start and end parameters are determined and a baton token is created along with a rule for coupling the baton token to the process-flow-triggering resource. In one embodiment, the baton token comprises an extensible mark-up language (XML) document. Artifact instance matching is then performed in step 306 and the baton token is coupled to the process-flow-triggering resource.

In step 308, the baton token collects actual (realflow) process step information as the process-flow-triggering resource progresses through each of the process steps of the predetermined IT process. Step 308 further comprises a plurality of IT process stakeholder/roles 310, and a plurality of realflow process steps 312. In process step 314, a process engineer designates an artifact type, such as a requirements document, which is then used by a business user in process step 316 to submit their requirements to an IT manager. The IT manager receives the submitted requirements and assigns them a priority in process step 318. In one embodiment, the same IT manager subsequently approves the requirements in process step 320 and assigns the requirements in process step 322. In another embodiment, different IT managers approve the requirements in process step 320 and assign the requirements in process step 322. In process step 324, an IT practitioner designs the implementation of the requirements and the same or another IT practitioner converts the requirements to a change management request (CMR) is process step 326. An IT practitioner accepts the CMR in process step 328 and the same or another IT practitioner creates a project for the CMR in an integrated development environment (IDE) in process step 330. Development artifacts are checked into a version control system, such as control versioning system (CVS), in process step 332 by an IT practitioner, and the state of the CMR is changed to “complete” by the same or another IT practitioner in process step 334. A test case is created in the test tool of an IT governance system by an IT practitioner in process step 336. An IT practitioner checks the project out of the versioning control system in process step 340 for testing in process step 340 and the project is checked back in by the IT practitioner in process step 342.

In step 344, the predetermined artifact designated as the process-flow-triggering resource reaches a state that matches the end parameter of the rule coupled to the baton token. In one embodiment, the captured realflow process steps contained in the baton token are converted into a realflow process flow representation. Comparison operations are then performed in step 346 by a project to compare the top-down, desired process flow representation to the realflow process flow representation. Once comparison operations are completed, a project manager assesses the compliance of the realflow process flow representation to the top-down, desired process flow representation in step 348 and makes recommendations. After assessment by the project manager is completed, the two process flows are reconciled in step 350 by a project engineer to generate an optimal top-down process. Realflow process step operations are then ended in step 352.

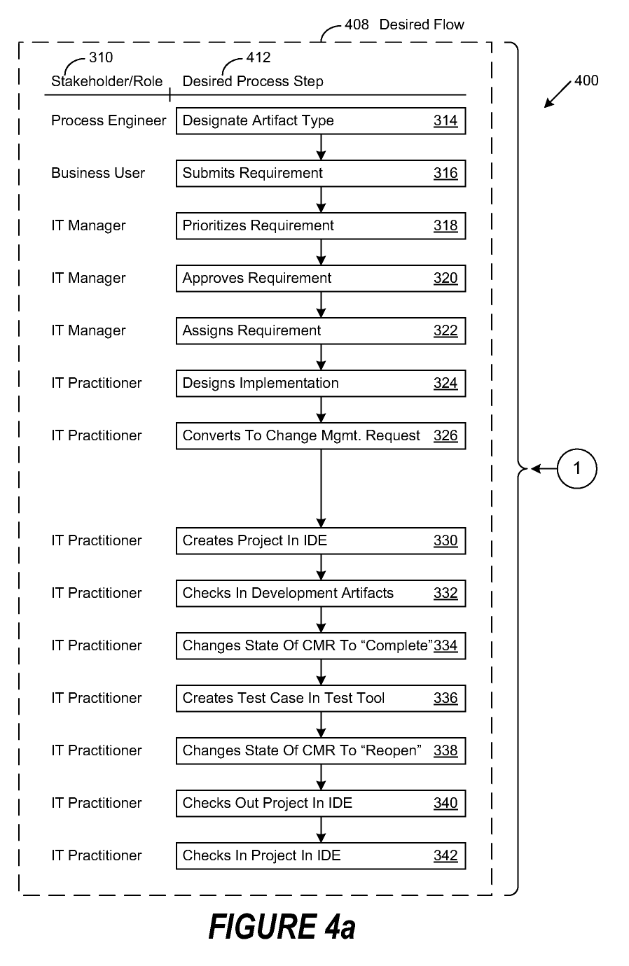

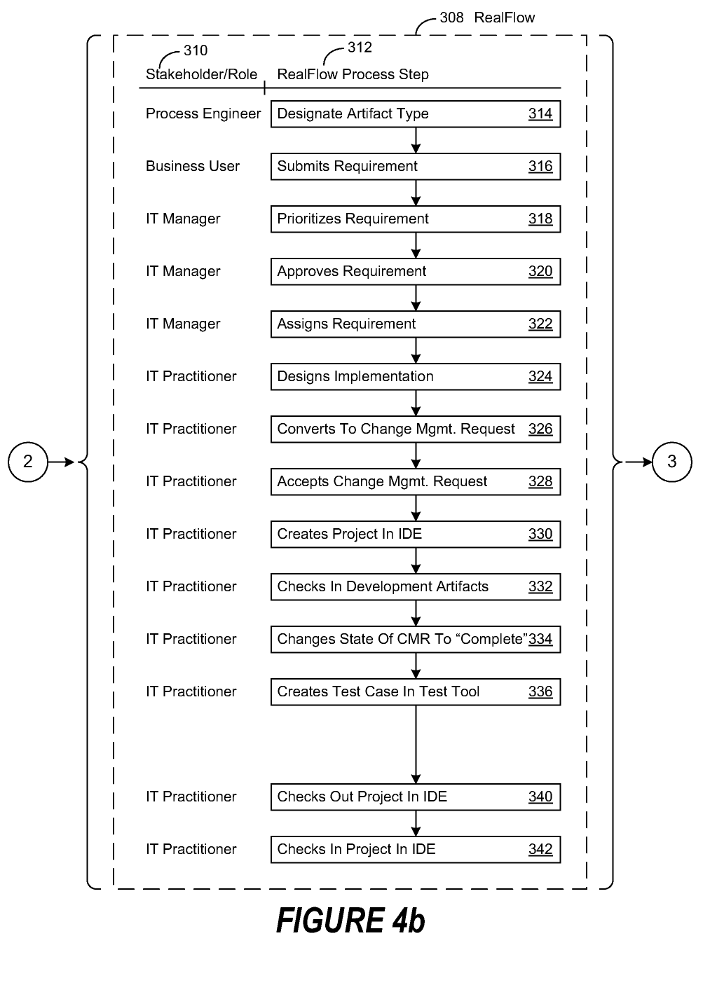

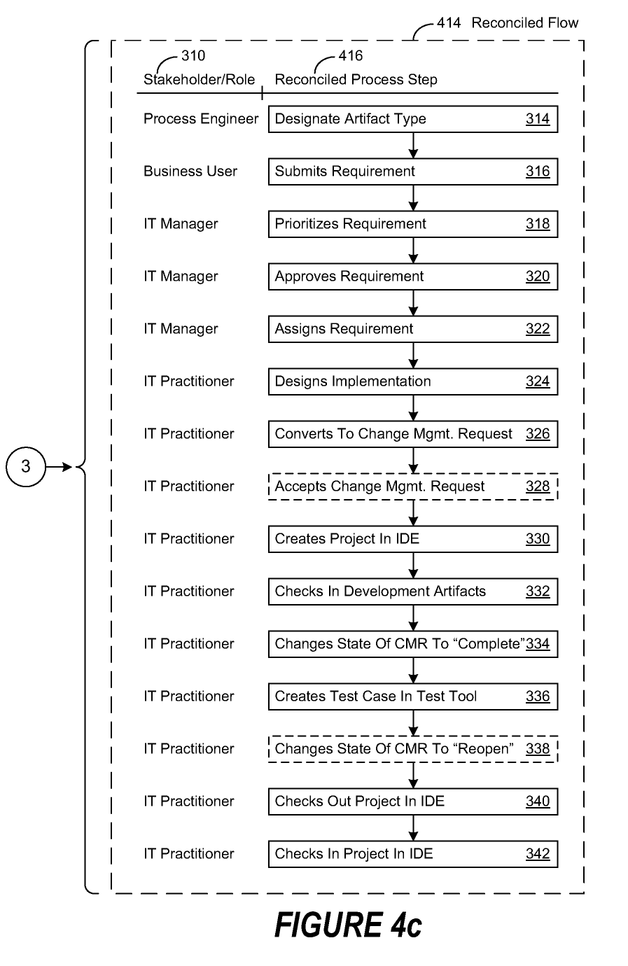

FIGS. 4a-c are simplified block diagrams of a baton token as implemented for the reconciliation 400 of realflow process steps with desired process steps in accordance with an embodiment of the invention. FIG. 4a illustrates a desired flow 408 of a predetermined IT process that comprises a plurality of stakeholder/roles 310 and desired process steps 412.

In process step 314, a process engineer designates an artifact type, such as a requirements document, which is then used by a business user in process step 316 to submit their requirements to an IT manager. The IT manager receives the submitted requirements and assigns them a priority in process step 318. In one embodiment, the same IT manager subsequently approves the requirements in process step 320 and assigns the requirements in process step 322. In another embodiment, different IT managers approve the requirements in process step 320 and assign the requirements in process step 322. In process step 324, an IT practitioner designs the implementation of the requirements and the same or another IT practitioner converts the requirements to a change management request (CMR) in process step 326. An IT practitioner then creates a project for the CMR in an integrated development environment (IDE) in process step 330. Development artifacts are checked into a version control system, such as control versioning system (CVS), in process step 332 by an IT practitioner, and the state of the CMR is changed to “complete” by the same or another IT practitioner in process step 334. A test case is created in the test tool of an IT governance system by an IT practitioner in process step 336. In step 338, the state of the CMR is changed to “reopen” by an IT practitioner. An IT practitioner then checks the project out of the versioning control system in process step 340 for testing in process step 340 and the project is checked back in by the IT practitioner in process step 342.

FIG. 4b illustrates a realflow 308 of a predetermined IT process that comprises a plurality of stakeholder/roles 310 and realflow process steps 312. As described in greater detail herein, a baton token is coupled to a process-flow-triggering resource. As the process-flow-triggering progresses through each of the process steps of a predetermined IT process, it collects process actual (realflow) process step information.

In process step 314, a process engineer designates an artifact type, such as a requirements document, which is then used by a business user in process step 316 to submit their requirements to an IT manager. The IT manager receives the submitted requirements and assigns them a priority in process step 318. In one embodiment, the same IT manager subsequently approves the requirements in process step 320 and assigns the requirements in process step 322. In another embodiment, different IT managers approve the requirements in process step 320 and assign the requirements in process step 322. In process step 324, an IT practitioner designs the implementation of the requirements and the same or another IT practitioner converts the requirements to a change management request (CMR) in process step 326. An IT practitioner accepts the CMR in process step 328 and the same or another IT practitioner creates a project for the CMR in an integrated development environment (IDE) in process step 330. Development artifacts are checked into a version control system, such as control versioning system (CVS), in process step 332 by an IT practitioner, and the state of the CMR is changed to “complete” by the same or another IT practitioner in process step 334. A test case is created in the test tool of an IT governance system by an IT practitioner in process step 336. An IT practitioner checks the project out of the versioning control system in process step 340 for testing and the project is checked back in by the IT practitioner in process step 342. Once the realflow has been captured by the baton token, it is converted to a realflow process representation.

FIG. 4c illustrates the result of reconciling realflow 308 to desired flow 408 to produce a reconciled flow 414. In an embodiment of the invention, comparison operations are performed between the process steps that are respectively contained in desired flow 408 and realflow 308. As a result of the comparison operations, it is discovered that desired flow 408 comprises process step 338, where an IT practitioner changes the state of a change management request (CMR) to “reopen.” Yet process step 338 was not captured by the baton token as a realflow process step. Conversely, realflow 308 comprises process step 328, where an IT practitioner accepts a change management request (CMR), which was not a process step of desired flow 408. Yet process step 328 was captured by the baton token as a realflow process step in realflow 308.

Reconciliation operations are performed between desired flow 408 and realflow 308 with the result that a reconciled flow 414 is generated comprising stakeholder/roles 310 and reconciled process steps 416. In process step 314, a process engineer designates an artifact type, such as a requirements document, which is then used by a business user in process step 316 to submit their requirements to an IT manager. The IT manager receives the submitted requirements and assigns them a priority in process step 318. In one embodiment, the same IT manager subsequently approves the requirements in process step 320 and assigns the requirements in process step 322. In another embodiment, different IT managers approve the requirements in process step 320 and assign the requirements in process step 322. In process step 324, an IT practitioner designs the implementation of the requirements and the same or another IT practitioner converts the requirements to a change management request (CMR) in process step 326. An IT practitioner accepts the CMR in process step 328 and the same or another IT practitioner creates a project for the CMR in an integrated development environment (IDE) in process step 330. Development artifacts are checked into a version control system, such as control versioning system (CVS), in process step 332 by an IT practitioner, and the state of the CMR is changed to “complete” by the same or another IT practitioner in process step 334. A test case is created in the test tool of an IT governance system by an IT practitioner in process step 336. In step 338, the state of the CMR is changed to “reopen” by an IT practitioner. An IT practitioner then checks the project out of the versioning control system in process step 340 for testing in process step 340 and the project is checked back in by the IT practitioner in process step 342.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for capturing information technology (IT) process flow step information, comprising:
using a process resource to perform a set of processing steps corresponding to an actual IT process flow comprising a plurality of individual process flow steps;
associating a token file with said process resource, said token file being configured to store process flow step information corresponding to individual steps in said actual IT process flow;
storing process flow step information in said token file for each process step in said actual IT process flow;
converting said process flow step information stored in said token file into a process flow representation comprising a set of actual process flow steps of said IT process flow;
comparing said set of actual process flow steps to a set of desired process flow steps comprising a desired IT process flow; and
generating a difference set of process flow steps comprising:
a) actual process flow steps not contained in said set of desired process flow steps; and
b) desired process flow steps not contained in said set of actual process flow steps.

2. The method of claim 1, wherein said actual IT process flow is modified by removing predetermined actual process flow steps in said difference set from the set of actual process steps in said actual IT process flow.

3. The method of claim 1, wherein said actual IT process flow is modified by adding predetermined desired process flow steps in said difference set to the set of actual process steps in said actual IT process flow.

4. The method of claim 1, wherein said actual IT process flow is modified by adding all desired process flow steps in said difference set and deleting all actual process flow steps in said difference sets.

5. The method of claim 1, wherein said desired IT process flow steps are used to generate a desired work breakdown structure.

6. The method of claim 5, wherein said desired work breakdown structure is used to modify said actual IT process flow in accordance with predetermined governance constraints.

7. A system comprising:
a processor;
a data bus coupled to the processor; and
a computer-usable medium embodying computer program code, the computer-usable medium being coupled to the data bus, the computer program code for capturing information technology (IT) process flow step information within an IT governance system and comprising instructions executable by the processor and configured for:
using a process resource to perform a set of processing steps corresponding to an actual IT process flow comprising a plurality of individual process flow steps;
associating a token file with said process resource, said token file being configured to store process flow step information corresponding to individual steps in said actual IT process flow;
storing process flow step information in said token file for each process step in said actual IT process flow;
converting said process flow step information stored in said token file into a process flow representation comprising a set of actual process flow steps of said IT process flow;
comparing said set of actual process flow steps to a set of desired process flow steps comprising a desired IT process flow; and
generating a difference set of process flow steps comprising:
a) actual process flow steps not contained in said set of desired process flow steps; and
b) desired process flow steps not contained in said set of actual process flow steps.

8. The system of claim 7, wherein said actual IT process flow is modified by removing predetermined actual process flow steps in said difference set from the set of actual process steps in said actual IT process flow.

9. The system of claim 7, wherein said actual IT process flow is modified by adding predetermined desired process flow steps in said difference set to the set of actual process steps in said actual IT process flow.

10. The system of claim 7, wherein said actual IT process flow is modified by adding all desired process flow steps in said difference set and deleting all actual process flow steps in said difference sets.

11. The system of claim 7, wherein said desired IT process flow steps are used to generate a desired work breakdown structure.

12. The system of claim 7, wherein said desired work breakdown structure is used to modify said actual IT process flow in accordance with predetermined governance constraints.

13. A computer-usable medium embodying computer program code, the computer program code comprising computer executable instructions configured for:
using a process resource to perform a set of processing steps corresponding to an actual IT process flow comprising a plurality of individual process flow steps;
associating a token file with said process resource, said token file being configured to store process flow step information corresponding to individual steps in said actual IT process flow;
storing process flow step information in said token file for each process step in said actual IT process flow;
converting said process flow step information stored in said token file into a process flow representation comprising a set of actual process flow steps of said IT process flow;
comparing said set of actual process flow steps to a set of desired process flow steps comprising a desired IT process flow; and
generating a difference set of process flow steps comprising:
a) actual process flow steps not contained in said set of desired process flow steps; and
b) desired process flow steps not contained in said set of actual process flow steps.

14. The computer usable medium of claim 13, said actual IT process flow is modified by removing predetermined actual process flow steps in said difference set from the set of actual process steps in said actual IT process flow.

15. The computer usable medium of claim 13, wherein said actual IT process flow is modified by adding predetermined desired process flow steps in said difference set to the set of actual process steps in said actual IT process flow.

16. The computer usable medium of claim 13, wherein said actual IT process flow is modified by adding all desired process flow steps in said difference set and deleting all actual process flow steps in said difference sets.

17. The computer usable medium of claim 13, wherein said desired IT process flow steps are used to generate a desired work breakdown structure.

18. The computer usable medium of claim 17, wherein said desired work breakdown structure is used to modify said actual IT process flow in accordance with predetermined governance constraints.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
